(19) United States
(12) Patent Application Publication
(10) Pub. No.: US 2026/0161922 A1
(43) Pub. Date: Jun. 11, 2026

(54) System and Method Using Tile-Based Attention for Sensor-Based Multi-Layer Perceptron

(71) Applicant: University of Windsor, Windsor (CA)

(72) Inventors: Mitra MIRHASSANI, LaSalle (CA); Hassan Rekabi BANA, Windsor (CA); Moslem HEIDARPUR, Manotick (CA)

(21) Appl. No.: 19/410,330

(22) Filed: Dec. 5, 2025

Related U.S. Application Data
(60) Provisional application No. 63/728,782, filed on Dec. 6, 2024.

(51) Int. Cl. G06N 3/04

(52) U.S. Cl. CPC G06N 3/04

(57) ABSTRACT

The invention relates to the implementation and application of sparsity in multi-layer perceptron (MLP) neural networks, and in particular to sparsely connected (SC) MLPs having reduced processing and power requirements, which may advantageously allow for implementation using integrated circuits (ICs) or field-programmable gate arrays (FPGAs). Preferred embodiments of the invention include both separate and overlapped tile-based attention MLPs using a predefined pattern (or mask) in forward computations, the pattern composed of a cascading matrix pattern of 0s and 1s, the pattern operable to assemble a sparse pattern in the neural network, particularly in the first junction, and which may advantageously keep fan-in for the first hidden layer of the MLP fixed. The invention also encompasses embodiments of sensor-based systems or embedded devices having limited processing power, which incorporate ICs or FPGAs implementing separate and/or overlapped tile-based attention MLPs according to the invention for the performance of regression and/or classification tasks.

### FIELD OF THE INVENTION

The present invention generally relates to the implementation of machine learning, and preferably the implementation of neural networks, on sensors and other embedded devices having reduced processing capabilities, and in particular to sensors and devices operable using sparsification in multi-layer perceptron (MLP) models.

### BACKGROUND OF THE INVENTION

Machine learning is a subfield of artificial intelligence that allows software applications to become more accurate at predicting outcomes without being explicitly programmed. It plays a crucial role in addressing complex challenges across various real-world problems like natural language processing, computer vision, intelligent healthcare, smart cybersecurity systems, and more.

Research has also discovered some similarities between human brains and artificial neural networks. While biological brains are sparsely connected and hierarchically arranged, artificial neural networks are traditionally fully connected. The sparsity observed in mammalian brains led to a significant rise in human brain capabilities and has motivated a variety of machine learning algorithms. Furthermore, the more neurons a brain contains, the sparser it reaches. Research has also revealed that in its development, the human brain forms sparse, contains an early dense phase followed by enormous pruning, and then stays at a relatively constant level of sparsity.

Recently, several studies focused on reducing mathematical computation while attempting to maintain model accuracy. The cost for modern networks such as Inception-V3 and GPT-3 exponentially increase. For example, the former design for object recognition needs 5.7 billion mathematical functions and 27 million parameters for evaluation. The latter, however, presented for natural language processing, requires 175 billion parameters to be evaluated. Consequently, supercomputers are a requirement and solution for deep neural network training.

Heretofore, the use of artificial intelligence (AI) in optical sensors and other embedded devices such as Field Programmable Gate Arrays (FPGAs), IoT devices, smart sensors and other wearable technology having low processing capabilities themselves has not proven commercially viable. In particular, computation requirements associated with conventional neural network processing makes the use of AI with such sensors impractical.

In addition, sensors and embedded devices which operate using AI operate with increased power demands. As a result, with EV power vehicles and other apparatus, there is a need to provide sensor systems which operate using AI processing with deep decreased processing and power requirements.

### SUMMARY OF THE INVENTION

Accordingly, an object of the invention is to provide a method for machine learning which requires lowered processing capabilities. More preferably, the invention provides a method of machine learning using sparsification in multi-layer perceptron (MLP) models which is operable with sensors and other embedded devices having limited processing power.

With the present invention, the inventors have recognized that a solution to address the high cost of training and inference in sensor and embedded technologies could be sparsification. Deep neural networks, especially their fully-connected layers, tend to have excessive parameters and over-fit the training data. Studies have shown that deep neural networks can be implemented effectively with only ten percent of their total parameters. The applicant has recognized that reducing parameters does not lead to significant performance degradation. Rather, with the current invention, the applicant has explored implementation of using lower density networks.

In non-limiting embodiments, the present invention may provide an embedded device and/or a sensor system which incorporates sensors that operate with comparatively low processing capabilities and power requirements. More preferably, the system sensors are in electronic communication with a processor which operates to effect signal analysis using preselected and stored sparse neural networks in data computation and signal output. In such systems, sensors may include by way of non-limiting example, image sensors used to detect electromagnetic radiation in the visible, UV and/or IR wavelength ranges, as well as ultrasonic based sensors. Such sensors may be used in industrial applications, as well as in vehicles for autonomous operation as well as cruise and/or crash control, as well as those used in driver fatigue detection systems, LIDAR sensors, night vision sensors. Other applications include uses in sensor-less brushless motor drives for controlling motors and the like.

The present method utilizes tile-based attention for multi-layer perceptrons (MLPs) enrolling regular sparsity, rather than randomized algorithms. In one aspect, the methodology applies a predefined and repeated algorithm for sparsity, where each neuron on the first hidden layer is linked to a fixed and predefined tile of inputs. The model can act similarly to dense models using regular sparsity, requiring fewer parameters and smaller computation time. This method has the potential to be applied to different MLP architectures and datasets, making it promising for use in machine learning not only with conventional AI processing and applications, but preferably also with single sensors and other low processing and/or low power devices.

More preferably, the present method and apparatus provides two methods of sparsity: separate and overlapped tile-based attention. The overlapped tile-based attention method serves as an extended version of the separate tile-based attention method.

In one embodiment, the tile-based attention only appears on a foremost junction, and preferably is built using patched windows with overlapped pixels. The present method manipulates the idea behind kernel and stride on Conventional Neural Networks, allowing to reserve more neurons for the first hidden layer. Each neuron of the first hidden layer is connected to the patches in consecutive order, and all other connections are removed. In order to reach the highest possible sparsity, one can divide images such as benchmark datasets: Modified National Institute of Standards and Technology (MNIST) and Kuzushiji-MNIST (KMNIST), a drop-in replacement for the MNIST dataset, and preferably into 49 tiles with 16×16 pixels. KMNIST consists of 28×28 grayscale images with a total of 70,000 images, provided in both the original MNIST format and a NumPy format. Each neuron in the first-hidden layer is consecutively connected to one tile, and all other connections are removed.

According to one embodiment, a first method for sparsity connects the first-hidden-layer neurons to patches of inputs, and preferably 49 separate patches. According to another embodiment, a second method has a higher connection rate and higher trainable parameters are provided.

The applicant has also introduced an improvement factor in hardware implementation for speed. Since the improvement factor for the first topology is higher than the second method; with the first method, implementation is only effected with separate tile-based attention using a multiply-and-accumulate (MAC) unit. Using this unit helps to reduce the total number of resources and is a promising candidate for Field Programmable Gate Arrays (FPGAs) with lower resources. The simulation results presented by way of this application show a very high performance in latency, while the area consumption is quite small. The benefit of the present methods is the use of regular sparsity and regular attention, leading to scale-down resource utilization. As will be described, simulation results also indicate a very small latency, which means high speed accelerators due to the small number of trainable parameters.

In another embodiment, introducing a window and regular attention, or overlap tile based attention, as opposed to employing full attention or a fully connected network, is recognized as allowing a first hidden layer of neurons to focus on local information rather than a comprehensive view. This attention mechanism enables the reduction and elimination of numerous redundant parameters without decreasing accuracy, especially in overlapped methods. Moreover, without being bound by a particular theory, with this method there is an expectation of achieving significantly faster computation compared to a fully connected network, since the total number of parameters is highly reduced in inference implementation.

In a preferred embodiment, to minimize the number of calculations, pruning or random elimination for the first junction is preferably introduced. These involve a pattern composed of ones and zeros, instructing a multiple and accumulation (MAC) unit to determine whether to perform computations or not. It is recognized that whilst these reduce random access memory (RAM) size, they do not enhance delay. The present method may not only reduce RAM size, but also substantially enhance computational efficiency by streamlining window calculations for each neuron located in the first hidden layer. Storing patterns for commanding the MAC unit is unnecessary, resulting in a notable reduction in latency when compared to pruned or randomized sparsification methods.

In another embodiment, the applicant's invention provides sparsity for neural networks, and preferably a multi-layer perceptron (MLP) as a fundamental layer of the deep neural network. Most preferably, the sparsity is predetermined and stored in processor memory as reducing the number of required neural connections whilst maintain an optimized or preselected degree of accuracy. The invention provided most preferably has the following advantages and/or characteristics:
1) The method provides sparsity for the first junction of MLP. Since the weight distribution density of the first junction is near-zero, this junction has the most robustness against sparsity. The present method exploits structured and symmetrical weights for training and inference of the neural network. The present method preferably defines tiles of input, and each tile is attached to the first hidden layer neurons. Thus, there is a linear relation between the number of first-hidden-layer neurons and the dimension of tiles, making total connections reduced.
2) Optionally, the present method incorporates one or more of two methods of connection: separate- and overlap-tile attention. The separate tile attention provides similar weights for the first junction as the input.
3) The use of tile sparsity in the present invention allows for fast inference and improved prediction time per second. This capability is achieved whereby each neuron in the first hidden layer is connected symmetrically to an input tile, which is a fraction of the input. Typically, the first hidden layer computation adds the least possible delay or latency to the inference, as only one tile is used for each neuron computation and all other tiles for a particular neuron are removed.
4) Symmetrical and regular weight usage in the first junction may be attributed to a very simple control unit and easy implementation in the overall design. Because the weights are symmetrically arranged, there is no need to select them randomly during the process of inference; they can be selected only with counters and sequential circuits. In fact, the control unit is comprised only of counters, which is preferable for simplified processing by sensors and other embedded devices having low processing capabilities.
5) Since the number of parameters for the densest junction declines due to tile connection, the memory footprint required for inference is also decreased. The applicant has appreciated that both the number of computations and the memory requirements of associated hardware and processors simultaneously may be successfully reduced.
6) Even though the applicant has reduced the number of parameters due to tile connection, system accuracy is not sacrificed. Even with overlap technology, there is no or minimal decline in accuracy for inference.
7) Fast inference requires parallel processing or several processing units. The present technology is capable of reaching high accuracy using a minimal number of multiplications and processing units. This capability is achieved through the use of tile connections, with redundant weights removed.
8) One main application of the present invention is to implement neural networks on sensors and other types of embedded devices with limited resources, a limited number of processing units, and/or a limited number of digital inputs. Advanced neural network capabilities may thus be used with resource-constrained applications like IoT devices, wearable technology, and smart sensors, which often require real-time or fast computation. Additionally, the reduction in computation can lead to reduced power consumption, making it an excellent candidate for battery-driven devices.

Accordingly, in one or more non-limiting aspects, the invention resides in an external non-volatile memory device, preferably an SPI flash memory chip, storing thereon a bitstream including configuration data for programming a Field-Programmable Gate Array (FPGA), said configuration data including instructions executable by a computer processor or one or more components of the FPGA, and which when executed by the computer processor or the one or more components of the FPGA effectuate physical rewiring and reconfiguration/transformation of the FPGA into a custom hardware accelerator for a sparsely-connected (SC) artificial neural network, namely a Multi-Layer Perceptron (MLP), the SC MLP including an interconnected layers architecture, and in particular including: an input layer (0) including N₀ neurons; one or more hidden layers including N₍ᵢ₋₁₎ and Nᵢ neurons, respectively, in earlier and later layers of the one or more hidden layers; an output layer (L) including N_{L} neurons; a first junction between the input layer (0) and a first hidden layer (1) of the one or more hidden layers, the first junction having a weight matrix W₁; one or more junctions between successive layers of the one or more hidden layers, the one or more junctions each having a weight matrix Wᵢ; and a final junction between a last hidden layer (L−1) of the one or more hidden layers and the output layer (L), the final junction having a weight matrix W_{L}; wherein predictive forward computations of the SC neural network are calculated using a regular, predefined pattern or mask P that is operable to assemble a sparse pattern in the neural network, particularly in the first junction, wherein the pattern P is also applied in backpropagation paths for training and learning; and wherein fan-in for the first hidden layer (1) is kept fixed using the pattern P.

The external non-volatile memory device according to any preceding or hereafter described aspects, wherein the pattern P includes a cascading matrix pattern of 0s and 1s, wherein the matrix is primarily filled by 0s with a plurality of substantially parallel, staggered and downward slanting lines of 1s descending slowly from a substantially upper left corner of the matrix across to a substantially lower right corner of the matrix in a substantially thin and substantially step-wise, diagonal pattern; and wherein the pattern P is preferably produced by way of a predefined algorithm for achieving separate tile-based attention.

The external non-volatile memory device according to any preceding or hereafter described aspects, wherein the pattern P comprises a cascading matrix pattern of 0s and 1s, wherein the matrix is primarily filled by 0s with a plurality of substantially parallel, staggered and downward slanting lines of 1s descending from an upper left portion of the matrix across to a lower right portion of the matrix, and forming a relatively thicker grouping of substantially parallel lines in a substantially diagonal pattern; and wherein the pattern P is preferably produced by way of a predefined algorithm for achieving overlapped tile-based attention.

The external non-volatile memory device according to any preceding or hereafter described aspects, wherein the input layer (0) includes a collection of tiles, preferably 49 tiled windows each including 4×4 pixels; wherein the first hidden layer (1) preferably includes 49 neurons; and wherein each neuron of the first hidden layer (1) is symmetrically connected to a single window and ignores all other windows.

The external non-volatile memory device according to any preceding or hereafter described aspects, wherein the input layer (0) includes a collection of tiled windows which are successively read and fed to the MLP from an input measuring A×A pixels, using a stride measurement selected from 1 to A and a Window Size of B×B pixels, wherein B is smaller than A; wherein a number of neurons N₁ in the first hidden layer (1) is calculated using a predefined formula for overlapped tile-based attention, wherein Input Size is A, Window Size is B and Stride is the stride measurement selected from 1 to A.

The external non-volatile memory device according to any preceding or hereafter described aspects, wherein the MLP is used to perform regression and/or classification tasks.

Furthermore, in one or more non-limiting aspects, the invention resides in an FPGA programmed using an external non-volatile memory device according to any preceding or hereafter described aspects, the FPGA including: a plurality of configurable logic blocks (CLBs) including look-up tables (LUTs) and Flip-Flops (FFs); a plurality of digital signal processing (DSP) slices including multiply and accumulate (MAC) units; a Block RAM (BRAM) connected to an external memory interface; a plurality of programmable interconnects; and a plurality of input/output (I/O) blocks; wherein the bitstream is loaded into the BRAM from the external non-volatile memory device via the external memory interface and/or I/O blocks during a configuration phase; wherein each of the plurality of CLBs, DSP Slices and programmable interconnects, the BRAM and the I/O blocks are configured in accordance with the configuration data of the bitstream to reconfigure/transform the FPGA to function as the SC MLP; and wherein at least one of the MAC units are operable to perform computations and/or calculations for implementing at least one of the first junction, one or more junctions and final junction of the MLP.

In one or more non-limiting aspects, the invention also resides in a custom integrated circuit (IC) or Application-Specific Integrated Circuit (ASIC) designed and hard-wired to perform operations and calculations of, and to function as, a sparsely-connected (SC) artificial neural network, namely a Multi-Layer Perceptron (MLP), the SC MLP including an interconnected layers architecture, and in particular including: an input layer (0) including N₀ neurons; one or more hidden layers including N₍ᵢ₋₁₎ and Nᵢ neurons, respectively, in earlier and later layers of the one or more hidden layers; an output layer (L) including N_{L} neurons; a first junction between the input layer (0) and a first hidden layer (1) of the one or more hidden layers, the first junction having a weight matrix W₁; one or more junctions between successive layers of the one or more hidden layers, the one or more junctions each having a weight matrix Wᵢ; and a final junction between a last hidden layer (L−1) of the one or more hidden layers and the output layer (L), the final junction having a weight matrix W_{L}; wherein forward computations of the SC MLP are calculated using a regular, predefined pattern or mask P that is operable to assemble a sparse pattern in the neural network, particularly in the first junction; wherein the pattern P is also applied in backpropagation paths for training and learning; and wherein the pattern P is produced by way of a predefined algorithm having as input: a total number of input units (neurons) in the first hidden layer, a number of tile connections, and a sliding of a tile for connection of the first hidden layer to the input layer.

The IC or ASIC according to any preceding or hereafter described aspects, wherein, in the algorithm, the number of tile connections and the sliding of the tile for connection of the first hidden layer to the input layer are the same, which results in the pattern P suitable for implementing separate tile-based attention.

The IC or ASIC according to any preceding or hereafter described aspects, wherein, in the algorithm, the sliding of the tile for connection of the first hidden layer to the input layer is smaller than the number of tile connections, which results in the pattern P suitable for implementing overlapped tile-based attention.

In addition to the foregoing, in one or more non-limiting aspects, the invention resides in an Internet of Things (IoT) device that includes the IC or ASIC according to any preceding or hereafter described aspects.

Furthermore, in one or more non-limiting aspects, the invention resides in a smart sensor device including at least one of the IC or ASIC and the FPGA according to any preceding or hereafter described aspects.

In one or more non-limiting aspects, the invention further resides in an embedded device including at least one of the IC or ASIC and the FPGA according to any preceding or hereafter described aspects.

In one or more non-limiting aspects, the invention also resides in a smart sensor device including at least one of the IC or ASIC and the FPGA according to any preceding or hereafter described aspects.

Additionally, in one or more non-limiting aspects, the invention resides in a sensor system including at least one of the IC or ASIC or the FPGA according to any preceding or hereafter described aspects, the sensor system characterized by reduced processing and power requirements, and further including: at least one sensor; and a sensor interface connecting the at least one sensor to the IC/ASIC or the FPGA; wherein the at least one sensor is operable to measure a physical phenomenon and transmit the measurements in the form of data signals to the sensor interface; wherein the sensor interface is operable to receive the data signals, to convert the data signals into digital data interpretable by the IC/ASIC or the FPGA, and to transmit the digital data to the IC/ASIC or the FPGA; wherein the IC/ASIC or the FPGA is operable to receive the digital data, to analyze and interpret the data by means of forward propagation through the interconnected layers architecture in order to identify data patterns indicative of the physical phenomenon, and to output control signals in response to the data patterns.

The sensor system according to any preceding or hereafter described aspects, wherein the digital data interpretable by the IC/ASIC or the FPGA includes a plurality of two-dimensional images, each of the images preferably measuring 28×28 pixels divisible into 49 tiled windows each with 4×4 inputs; and wherein the IC/ASIC or the FPGA is further operable to assign and/or to compile the images to/into the input layer (0) of the MLP.

The sensor system according to any preceding or hereafter described aspects, wherein the interconnected layers architecture of the MLP is designed to contain a preselected minimum or maximum number of total neural connections between neurons of each of the input layer (0), the one or more hidden layers, and the output layer (L); and wherein the preselected minimum or maximum number of total neural connections is designed for achieving a target degree of system accuracy while also minimizing processing and power requirements of the MLP.

In one or more non-limiting aspects, the invention further resides in a wearable device including the sensor system according to any preceding or hereafter described aspects, wherein the physical phenomenon includes at least one of: temperature, heart rate, respiration, blood pressure, blood oxygen, sweat, tears, body position, body movement, mechanical movement, or other physiological signals; and wherein the at least one sensor is selected from the group consisting of: temperature sensors, accelerometers, gyroscopes, optical heart rate sensors, position and/or displacement sensors, pressure sensors, resistive sensors and other physiological sensors including electrocardiogram (ECG), photoplethysmography (PPG), electromyography (EMG), blood oxygen sensors and galvanic skin response (GSR) sensors; and wherein the control signal is operable to control an alarm or alert for alerting a user of the wearable device to a predefined medical or physiological state.

Furthermore, in one or more non-limiting aspects, the invention also resides a collision avoidance system, preferably for an autonomous or EV vehicle, including the sensor system according to any preceding or hereafter described aspects, wherein the physical phenomenon includes at least one of: electromagnetic radiation in the visible light and infrared wavelength range, vehicle speed and acceleration; and wherein the at least one sensor is selected from the group consisting of: image sensors, distance sensors, object detection sensors, lidar sensors, optical sensors, vehicle speed and braking sensors; and wherein the control signal is operable to control vehicle braking on occurrence of an identified collision threat.

Additionally, in one or more non-limiting aspects, the invention further resides in a method of operating a sensor system including at least one of the IC or ASIC and the FPGA according to any preceding or hereafter described aspects, the system characterized by reduced processing and power requirements, the method including: by way of at least one sensor, measuring a physical phenomenon and transmitting the measurements in the form of data signals to a sensor interface, the sensor interface connecting the at least one sensor to the IC/ASIC or the FPGA; receiving from the at least one sensor to the sensor interface, the data signals; by way of the sensor interface, converting the data signals into digital data interpretable by the IC/ASIC or the FPGA; by way of the sensor interface, transmitting the digital data to the IC/ASIC or the FPGA; receiving to the IC/ASIC or the FPGA the digital data; by way of the IC/ASIC or the FPGA, analyzing and interpreting the data by means of forward propagation through the interconnected layers architecture in order to identify data patterns indicative of the physical phenomenon; and outputting control signals in response to the data patterns.

Accordingly, non-limiting aspects of the present invention may further reside in one or more of the following aspects:
1. A sensor system comprising at least one sensor, the at least one sensor operable to sense object related attributable values, characterized by reduced processing power, a processor operable to identify data signal patterns from said sensors indicative of the object-related attributable value and output control signals in response to said signal patterns, the processor having memory having stored therein programme instructions for sparsification of neural network connections in a multi-layer perceptron:
   said at least one said sensor operable to receive said object related attributable values of a sensed object, and output to said processor a plurality of data signals indicative of the object related attributable values, said programme instruction being operable to effect said processor to:
(i) assign to the data signals to an input array, and preferably a 4×4, a 8×8, a 16×16, a 24×24 or a 36×36 array,
(ii) divide the data signals in the input array into one of an associated set of identical input tiles, each input tile having assigned thereto a label assigned to the data signals used for creating the input tile,
(iii) compile the input data signals in said tiles as an input layer of the multi-layer perceptron comprising connected neurons organized into a plurality of layers, said plurality of layers including a first-hidden layer, and wherein each neuron in the input layer is connected to neurons in the first-hidden layer in accordance with pre-stored sparsification instructions and substantially without other connections,
(iv) by separate attenuation or overlap-tile attenuation as an activation function of the multi-layer perceptron to effect learning on the tiles and of received data signals, and
(v) output an output attributable value derived from at least one subset of the tiles, and
   wherein the sensor system is operable to output said control signal based on said output attributable value.
2. A method of operating a sensor or sensor-less driver system comprising a processor one or more sensors having reduced processing power to identify data signal patterns indicative of an object-related attributable value, the processor having memory having stored therein stored-sparsification instructions for neural network connections in an artificial neural network, method comprising:
(i) receiving by at least one sensor or sensor-less driver, object related attributable values of a sensed object, and outputting to said processor a plurality of data signals indicative of the object related attributable values, (ii) by said processor, assigning to the data signals to any input array, and preferably a 4×4, a 8×8, a 16×16, a 24×24 or a 36×36 array,
(iii) by said processor, dividing the data signals in the input array into one of an associated set of identical input tiles, each input tile having assigned thereto a label assigned to the data signals used for creating the input tile,
(iv) by said processor, compiling the input data signals in said tiles as an input layer of the artificial neural network comprising connected neurons organized into a plurality of layers, said plurality of layers including a first-hidden layer, and wherein each neuron in the input layer is connected to neurons in the first-hidden layer in accordance with the stored sparsification instructions and substantially without other connections,
(v) by said processor, effecting, by at least one of separate attenuation and overlap-tile attenuation as an activation function of the artificial neural network to effect learning on the tiles and of received data signals,
(vi) outputting, by the sensor system, the output attributable value derived from at least one subset of the tiles.

A method or system in accordance with previously or hereafter described aspects wherein the stored instructions for sparsification of neural network connections comprise a preselected a minimum number of neural network connections which has been predetermined for a target degree of system accuracy.

A method or system in accordance with previously or hereafter described aspects wherein the at least one sensor comprises an image sensor operable to capture electromagnetic signals as said object related attributed value, and wherein said data signals output to said processor comprise pixels.

A method or system in accordance with previously or hereafter described aspects wherein the multi-layer perceptron includes a second hidden layer, the neurons of the first-hidden layer being connected to neurons in the second hidden layer in accordance with the stored instructions for sparsification of neural network connections and substantially without other connections.

A method or system in accordance with previously or hereafter described aspects wherein the multi-layer perceptron includes a plurality of hidden layers and an output layer, the neurons of each of the plurality of hidden layers being interconnected consecutively in accordance with the stored instructions for sparsification of neural network connections and without other connections.

A method or system in accordance with previously or hereafter described aspects wherein the step of connecting each unit is effected by a multiply-and-accumulation unit (MAC), and whereby prior to the step of assigning data signals, with the MAC sparsifying the first junction in accordance with the stored sparsification instructions.

A method or system in accordance with previously or hereafter described aspects wherein the at least on sensor comprises an image sensor wherein the received data signals forming an image, and the programme instructions further operable to control the processor to divide the image into a plurality of patches, and connect the first hidden-layer of neurons to the patches of the input data signals.

A method or system in accordance with previously or hereafter described aspects wherein said programme instructions are operable to connect the first hidden-layer to 49 separate said patches wherein the step of splitting comprises dividing the received data signals into 49 tiles comprising 16×16 pixels.

A method or system in accordance with previously or hereafter described aspects wherein said sensor is selected from the group consisting of an optical sensor, object detection sensor, and a sensor-less driver and preferably an autonomous vehicle sensor or an object detection sensor.

A method or system in accordance with previously or hereafter described aspects wherein the stored sparsification instructions are preselected as a minimum number of neural network connections predetermined for a target degree of system accuracy.

A method or system in accordance with previously or hereafter described aspects wherein the at least one sensor comprises an image sensor operable to capture electromagnetic radiation as light and/or colour signals as said object related attributed value, and wherein said data signals output to said processor comprise pixels.

A method or system in accordance with previously or hereafter described aspects wherein the artificial neural network includes a second hidden layer, the neurons of the first-hidden layer being connected to neurons in the second hidden layer in accordance with the stored-sparsification instructions and substantially without other connections.

A method or system in accordance with previously or hereafter described aspects wherein the artificial neural network includes a plurality of hidden layers and an output layer, the neurons of each of the plurality of hidden layers being interconnected consecutively in accordance with the stored-sparsification instructions and without other connections.

A method or system in accordance with previously or hereafter described aspects wherein the step of connecting each unit is effected by a multiply-and-accumulation unit (MAC), and wherein prior to the step of assigning data signals, with the MAC eliminating the first junction in accordance with the stored-sparsification instructions.

A method or system in accordance with previously or hereafter described aspects wherein said artificial neural network comprising a multi-layer perceptron (MVLP).

A method or system in accordance with previously or hereafter described aspects wherein the sensor comprises an optical sensors and the received data signals forming an image, and the method further comprising dividing the image into a plurality of patches, and connecting the first hidden-layer of neurons to the patches of the input data signals.

A method or system in accordance with previously or hereafter described aspects wherein said sensor system connects the first hidden-layer to 49 separate said patches wherein the step of splitting comprises dividing the received data signals into 49 tiles comprising 16×16 pixels.

A method or system in accordance with previously or hereafter described aspects wherein said system comprises a sensor system having at least one sensor selected from the group consisting of an image sensor, an optical sensor, object detection sensor, and a sensor-less driver.

A method or system in accordance with previously or hereafter described aspects wherein said image sensor comprises an autonomous vehicle sensor or an object detection sensor.

### BRIEF DESCRIPTION OF THE DRAWINGS

The advantages and features of the present disclosure will become understood with reference to the following more detailed description and claims taken in conjunction with the accompanying drawings, and in which:

FIG. 1 illustrates a Multi-Layer Perceptron (MLP) with two hidden layers, the first junction being sparse while other junctions are fully connected;

FIG. 2 illustrates a separate tile-based attention network with a lowest possible connection rate, in accordance with a preferred embodiment of the invention;

FIGS. 3 and 4 illustrate example matrix patterns (masks) for multiplication to the first junction in order to create a sparse junction for separate tile-based attention according to preferred embodiments of the invention;

FIG. 5 provides a window and stride definition for an overlapped tile-based attention network according to preferred embodiments of the invention;

FIGS. 6 and 7 illustrate example matrix patterns (masks) for multiplication to the first junction in order to create a sparse junction for overlapped tile-based attention according to preferred embodiments of the invention;

FIG. 8 provides a flow chart illustrating an inference of first junction on a Field Programmable Gate Array (FPGA) using a multiply-and-accumulate (MAC) unit;

FIG. 9 provides a flow chart illustrating different states for first junction calculation in the separate tile-based attention network according to embodiments of the invention, wherein five states or clock cycles are required for each parameter computation;

FIG. 10 provides a bar chart comparing the present method with state-of-the-art literature in terms of a Lookup table (LUT), Flip Flops (FF), and Block ROM utilizations, and wherein lower resource consumption is preferred;

FIG. 11 provides a bar chart comparing the present method with state-of-the-art literature in terms of latency, wherein lower latency means a faster accelerator, which is desired;

FIG. 12 illustrates an overlapped tile-based attention network in accordance with a further embodiment;

FIG. 13 illustrates schematically an electro-voltaic (EV) vehicle which incorporates a collision avoidance system operable to output vehicle commands in accordance with detected object-related attributable values using sparsity in accordance with the present invention; and

FIG. 14 illustrates a partial diagram of one possible example of a Field Programmable Gate Array (FPGA) and its components, which may be used in implementing preferred embodiments of the invention.

### DETAILED DESCRIPTION

The applicant has recognized that there are several benefits to using sparsity in neural networks. For example, sparsity can reduce the memory footprint of regular networks to fit mobile devices, as well as shorten training time for ever-growing networks. In addition, sparsity is recognized as leading to faster inference without degrading performance.

A prevalent and straightforward model for neural network implementation is the multi-layer perceptron (MLP). It comprises at least three layers: input, hidden and output. Accordingly, the MLP can be configured with one or more hidden layers. At the output of each node, there is a nonlinear activation function except for the input nodes. In each layer, the input vector is multiplied by a weight matrix, followed by adding a bias vector to each node.

MLPs can be considered a supervised learning algorithm and use backpropagation for the training phase. Data, which is not linearly separable, can be classified and approximated by an MLP network. It has been asserted that two hidden layers are often sufficient for various classification tasks. Furthermore, studies indicate that an MLP with only two hidden layers is often an adequate processor for both regression and classification tasks.

### i) Sparsity in Multi-Layer Perceptron

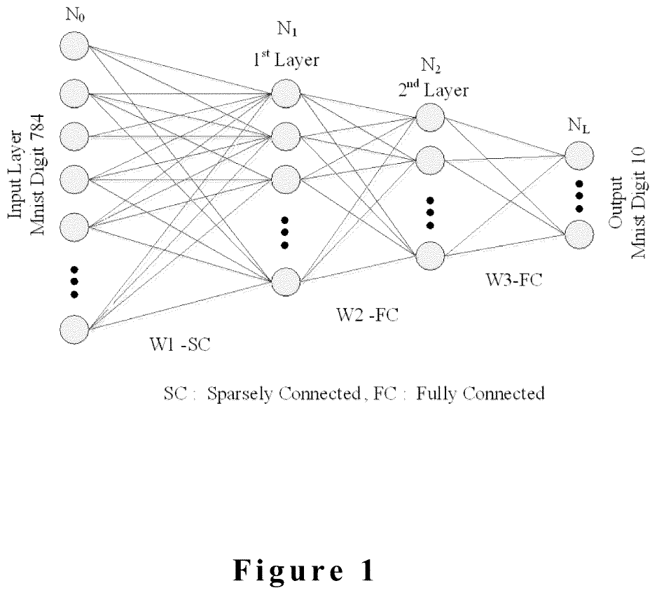

FIG. 1 shows sparsity in MLPs and notation described as follows: the input of the Neural Network is layer 0, and the output is layer L. The number of neurons placed in each layer is [N₀, N₁, . . . , N_{L}]. It contains L junctions between the layers. N₍ᵢ₋₁₎ and N stands for the number of neurons in the earlier and later layers of junction, respectively. Every left neuron includes a constant number of weights leaving from it to the right. And every right neuron includes a constant number of weights coming into it from the left. The fully-connected network will be formed when the parameters of junctions become maximized. The NNs can be designed without bias, total number of trainable parameters is N₀N₁+N₁N₂+ . . . +N_{(L-1)}N_{L}. If some of its junctions are removed, the sparsely-connected network will be formed.

In FIG. 1, the initial connection between No and N_{L} is shown as having the highest robustness against removal and sparsity.

In contrast with random sparsity, maintaining a constant number of junctions for each neuron guarantees that all neurons in a junction make an equal contribution and none of them will be disconnected. Furthermore, the disconnection results in information loss and recedes network performance. The junction density of each layer is an important feature of NNs calculated by Wᵢ/(NᵢN₍ᵢ₋₁₎). While junction density is 100% for fully-connected (FC) networks, sparsely-connected (SC) networks represent a network with a lower junction density.

It is recognized that the degrees of fan-out and fan-in determine the number of junctions to the subsequent layer and from the previous layer, respectively. In Table I (below), fan-in and fan-out of MLPs is considered. The applicant has developed a procedure to maintain the fan-in fixed, especially for the first-hidden layer neurons. The first-hidden layer comes after the input. In preferred aspects, the first-hidden-layer fan-in is kept constant and whereby, the network can be implemented by parallel processing. Another advantage is that there is no cause for concern about information loss due to considering all the inputs.

TABLE I
FAN-IN AND FAN-OUT FOR THE FIRST-
LAYER OF MULTI-LAYER PERCEPTRON.

| | FC Network | SC Network |
|---|---|---|
| Input Fan-out | N1 | Lower than N1 |
| First-hidden-layer Fan-in | N0 | Lower than N0 |

Dey et al. in their paper entitled “Accelerating training of deep neural networks via sparse edge processing,” 26th International Conference on Artificial Neural Networks, Alghero, Italy, Sep. 11-14, 2017, Proceedings, Part I 26 (pp. 273-280), the entirety of which is incorporated herein by reference, describes the advantage of a pseudo-random connection pattern to fix the input fan-out. By contrast, the present method does not make use of the randomized pattern. Instead, the applicant makes the best use of repeated and regular patterns to fix the first-hidden-layer fan-in.

In the following sections, two methods are described with the aim of making fan-in constant in a regular manner. One advantageous achievement is the introduction of repeated and regular patterns for the first junction (weight), which may increase the likelihood of achieving a straightforward and simpler network for training and inference.

### ii) Methods for Sparsity

Modified National Institute of Standards and Technology (MNIST) and Kuzushiji-MNIST (KMNIST) handwritten digits are very common for the input of neural networks. They are also beneficial for those considering pattern recognition methods and learning algorithms on real-world datasets, while pre-processing and formatting are not necessary.

Each image includes 28×28 pixels. In fully connected MLP networks, each neuron in the first hidden layer is connected to all pixels. For sparsity, images can be divided into several individual patches. Each neuron in the first-hidden layer is connected to a particular patch's pixels. In other words, neurons in this layer can be dedicated to estimating the information of one patch, followed by fully connected junctions. Therefore, all the junctions are fully connected except the first one. As long as tile connections make the sparsity, it is called separate tile-based attention and is described below in section A.

The separate tile-based attention may suffer from a degradation in performance; in order to reach higher accuracy, overlapped tile-based attention is desired and is thus described in section B.

### A—Separate Tile-Based Attention Network

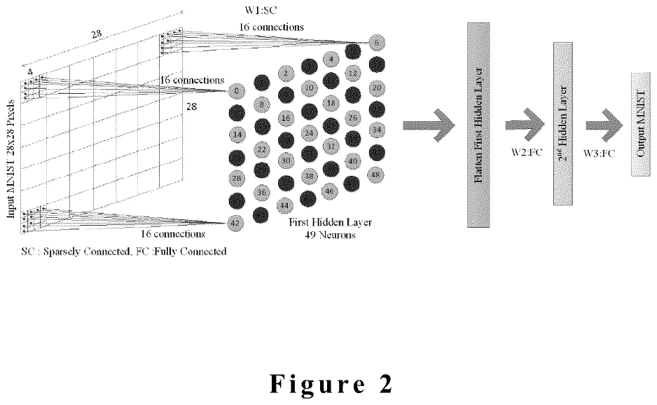

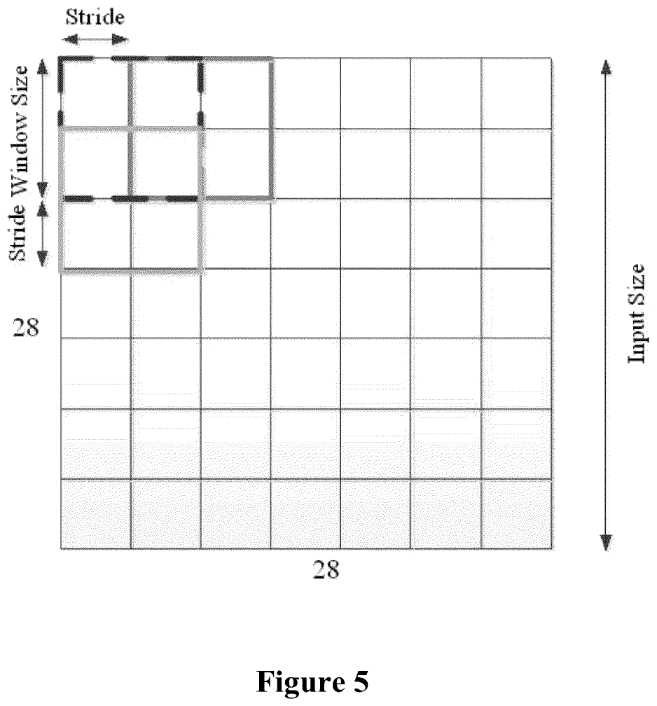

The lowest possible connection rate for tile-based attention is introduced in this section. A methodology is described in which each neuron in the first hidden layer is connected to a window of inputs (pixels). Since MNIST and KMNIST are two-dimensional inputs, including 28×28 pixels, they can be divided into 49 tiled windows with identical dimensions of 4×4 inputs, meaning that each window has 16 pixels. Each neuron in the first hidden layer is connected to one window and ignores all other windows. This condition makes us assign 49 neurons for the first hidden layer. One important note is that the total number of trainable parameters for the first junction will be 784. The two-dimensional connections used in the creation of a sparsely connected version of the neural network mode are shown in FIG. 2. In the method shown, the connections overlap instead of being separate. FIG. 5 further depicts a method in which each neuron is connected to overlapped windows, and is further applicable to the method shown with reference to FIG. 2, but with overlapping connections.

The connection rate for the first junction is extremely low. It is approximately 2% compared to the fully connected network. Concerning inference implementation on Field Programmable Gate Arrays (FPGAs) for the W₁ junction, a fully connected network needs 38416 weights to be stored in memory if N₁ is assumed to be 49. By contrast, the separate tile-based attention can be implemented by 784 consecutive weights stored in the memory. The reordering input technique allows one to reduce latency significantly, while a Linear-Feedback Shift Register (LFSR) method did not have any capability to decrease latency.

Before considering sparsely connected (SC) networks, consider fully connected (FC) networks. FC networks are equipped with N₀ input and N_{L} output nodes. Forward computations can be calculated by the weighted sum of the inputs and passing the result through an activation function, as show by Equation (1) below.

$${Y}_{i} = Act ( {\sum }_{i} {W}_{i} {X}_{i - 1} ) \qquad ( 1 )$$

Inputs and outputs are X and Y, respectively. W and Act define the weight matrix (junction) and activation function, respectively. Common activation functions Act include sigmoid and tanh (hyperbolic tangent) functions, ReLU (Rectified Linear Unit) and its variants, such as Leaky ReLU, PReLU (Parametric ReLU), and ELU (Exponential Linear Unit). These can be used in hidden layers for different applications. Particularly, because they may help mitigate the vanishing gradient problem and are computationally efficient.

Previous studies on individual junction statistics reported that many weights are zero or near zero after training, especially in the earlier junctions. This capacity encouraged the applicant to construct MLPs only with W₁ sparse. In Sparse MLPs, the traditional weight matrix W₁ is no longer used. Instead, a regular pattern (or mask) P is multiplied by W₁, as shown by way of Equation (2) below.

$${W}_{s} = {W}_{1} P \qquad ( 2 )$$

The pattern (mask) P is used to assemble a sparse pattern in the network. This pattern is applied in feedforward and backpropagation paths for training and inference.

Like a fully-connected (FC) network (see Equation (1) above), the calculation of the sparsely-connected (SC) network in the feed-forward can be written as follows:

$${Y}_{i} = Act ( {\sum }_{i} {W}_{s} {X}_{i - 1} ) \qquad ( 3 )$$

Consequently, the total number of trainable parameters can be decreased significantly.

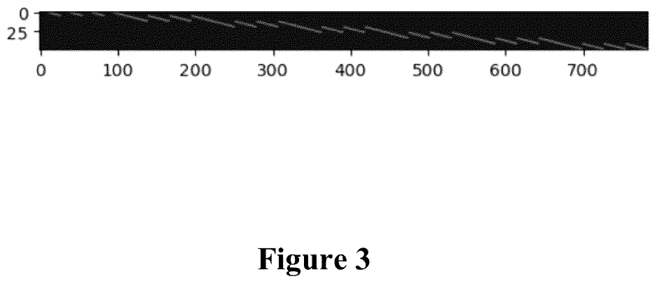

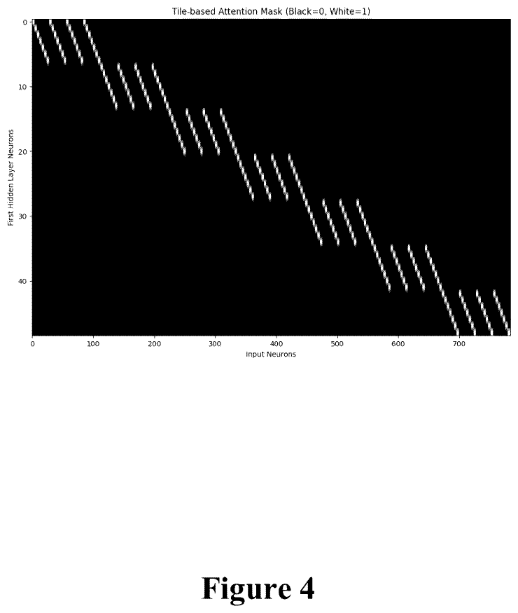

In separate tile-based attention MLP according to preferred embodiments of the present invention, the pattern (mask) P is a cascading matrix pattern (or mask) formed of zeros (0s) and ones (1s). In particular, the pattern (or mask) P is primarily filled by 0s with a plurality of substantially parallel, staggered and downward slanting lines of 1s descending from a substantially upper left corner of the matrix across to a substantially lower right corner of the matrix in a substantially step-wise, diagonal pattern, as for example is shown in FIGS. 3 and 4. In each of FIGS. 3 and 4, the horizontal axis represents the number of inputs, and the vertical axis represents the number of neurons at the first hidden layer. In FIG. 3, the black is zero (0), and the grey is one (1); and similarly in FIG. 4, the black is zero (0), and the white is one (1).

FIGS. 3 and 4 represent possible examples of the pattern (mask) P in separate tile-based attention according to possible embodiments of the invention. The applicant has appreciated that the pattern (mask) P can be adjusted or modified, so long as attention is maintained. The following Algorithm 1 is provided as one possible example code for generating the pattern (mask) P for separate tile-based attention:

Algorithm 1: The proposed mask for weight sparsity

```
  1: Input: N, K
  2:  ${N}_{1} ← {( \frac{N}{K} )}^{2}$
  3: M₀ ← Zeros N₁, N, N]
  4: Z ← 0
  5: Y ← 0
  6: while Y + K ≤ N do
  7: X ← 0
  8: while X + K ≤ N do
  9: M₀[Z, Y : Y + K, X : X +K ] ← 1
10: Z ← Z + 1
11: X ← X + K
12  end while
13: Y ← Y + K
14: end while
15: M₀ ← M₀.Reshape[N₁, N²]
16: Output: M₀
```

In the above Algorithm 1, N represents the total number of input units (neurons) in the first layer and K represents the number of tile connections. The matrix M₀ in the Algorithm 1 above is first generated in three dimensions (3D) having X, Y and Z axes and then converted into two dimensions (2D) with X and Y axes at step 15 of the algorithm. Once output, the matrix M₀ produced by way of Algorithm 1 may be used as the pattern (mask) P in Equations (2) and (3) above for separate tile-based attention.

In the following section, another sparsity method is described to have a higher number of neurons. Despite performing properly for MNIST, this method needs to be improved for KMNIST. More complicated datasets, such as KMNIST, need to be trained with a higher rate of connection rather than a 2% connection rate. The following section explains how to reach a higher connection rate for sparsity.

### B—Overlapped, Higher Connection Rate Tile-Based Attention Network

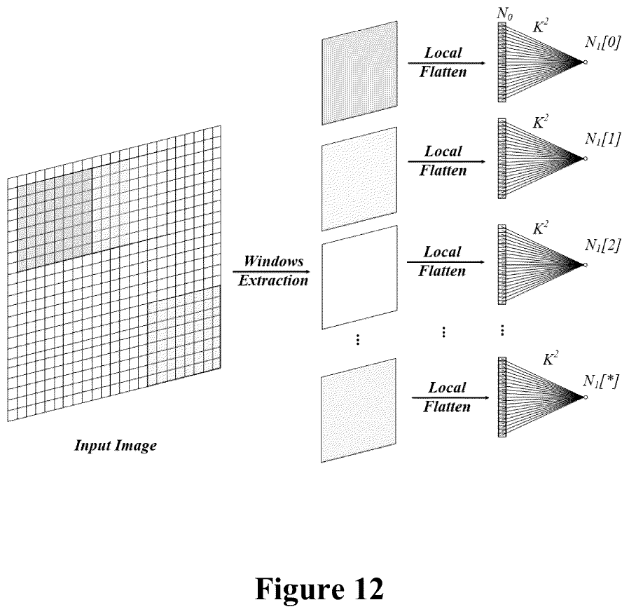

In the previous section, a sparsity method with limited patches was introduced. Since the MNIST dataset includes 28×28, the applicant made 49 individual patches from the images without overlaps. This sparsification is limited to only 784 connections for the first junction (W₁). Simulation results depicted that the sparsely connected network performed reasonably for MNIST but did not operate properly for KMNIST. Therefore, in other embodiment patches with overlapped capabilities may be desirable as for example is shown in FIG. 12, allowing to keep more attention than separate tile-based attention. It is prevalent to employ the convolution layer in neural networks. However, the applicant is unwilling to add any convolution layer to the network. The applicant benefits from the convolutional concept, which helps to gain an overlapped tile-based window with a regular arrangement. These overlapped tile-based windows can be implemented for sparsity in an organized form with a capability of reducing memory cells and latency simultaneously.

The overlapped tile-based attention is equipped with a window in which all the numbers are equal to one, and there are no trainable parameters on the window. A stride is another feature to make more neurons. For example, the sparsity method introduced in the previous section can be implemented by 4×4 windows and a stride of 4. All the inputs in each window are attached to one neuron in the first hidden layer, which is the central part of the design. Successive windows are also attached to successive neurons in the first hidden layer. This method can be implemented by parallel processing in contrast with the randomized number generator, such as the LFSR algorithm.

Imagine a neural network taking a KMNIST dataset and trying to analyze it. FIG. 5 displays window and stride in the method which enables one to assemble the overlapped tile-based attention. The red window includes 8×8 pixels. All the pixels will be attached to the first-hidden-layer first neurons. If one assumes the stride is equal to four, all the inputs in the green square will be connected to the first hidden layer's second neuron. It will be repeated for all neurons of the first hidden layer in a successive way. Naturally, as the stride or movement decreases, the first-hidden-layer neurons will be increased. The number of neurons taken for the first layer is calculated as follows:

$${N}_{1} = {( \frac{Input Size - Window Size}{Stride} + 1 )}^{2} \qquad ( 4 )$$

For instance, if the input and window shape are assumed to be 28×28 and 8×8, respectively. Input size and window size will equal to 28 and 8, respectively. It is important to note that stride can be selected from 1 to the size of window, if one assumes the stride to be 2. From Equation (4) above, the total number of neurons in the first hidden layer is 121. Each neuron is connected to 8×8 windows. This procedure enables more attention than the previous tiled methods.

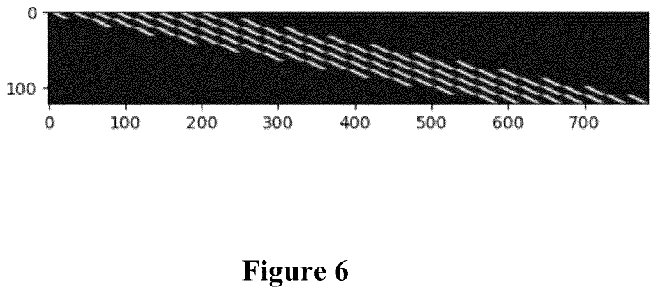

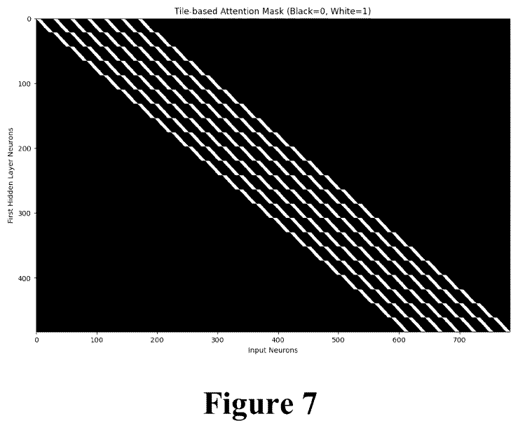

In overlapped tile-based attention MLP according to preferred embodiments of the present invention, the pattern (mask) P multiplied to the first junction is a cascading matrix pattern of 0s and is that is primarily filled by 0s with a plurality of substantially parallel, staggered and downward slanting lines of 1s descending from an upper left portion of the matrix across to a lower right portion of the matrix, and forming a relatively (in comparison to separate tile-based attention MLP) thicker grouping of substantially parallel lines in a substantially diagonal pattern, as for example is shown in FIGS. 6 and 7. In each of FIGS. 6 and 7, the horizontal axis represents the number of inputs, and the vertical axis represents the number of neurons at the first hidden layer. In FIGS. 6 and 7, the black is zero (0), and the white is one (1). This pattern (mask) is used for feedforward and backpropagation paths.

FIGS. 6 and 7 represent possible examples of the pattern (mask) P in overlapped tile-based attention according to possible embodiments of the invention. The applicant has appreciated that the pattern (mask) P can be adjusted or modified, so long as attention is maintained, and overlapped. The following Algorithm 2 is provided as one possible example code for generating the pattern (mask) P in overlapped tile-based attention:

Algorithm 2 The proposed mask for weight sparsity

```
  1: Input: N, K, S
  2:  ${N}_{1} ← {( \frac{N - K}{S} + 1 )}^{2}$
  3. M₀ ← Zeros N₁, N, N]
  4: Z ← 0
  5: Y ← 0
  6: while Y + K ≤ N do
  7:  X ← 0
  8:  while X + K ≤ N do
  9: M₀[Z, Y : Y + K, X : X +K ] ← 1
10:  Z ← Z + 1
11:  X ← X + S
12:  end while
13:  Y ← Y + S
14: end while
15: M₀ ← M₀.Reshape[N₁, N²]
16: Output: M₀
```

In the above Algorithm 2, N represents the total number of input units (neurons) in the first layer, K represents the number of tile connections, and S is sliding the tile for the connection of the first hidden layer to the input. The matrix M₀ in the Algorithm 2 above is first generated in three dimensions (3D) having X, Y and Z axes and then converted into two dimensions (2D) with X and Y axes at step 15 of the algorithm. Once output, the matrix M₀ produced by way of Algorithm 2 may be used as the pattern (mask) P in Equations (2) and (3) above for overlapped tile-based attention. The applicant has appreciated that Algorithms 1 and 2 are similar, but that in separate tile-based attention, the variables S and K (from Algorithm 2) are assumed to be the same. While for different values and overlapped tile attention, S should be smaller than K.

Accordingly, Equation (3) is the same for both separate and overlapping methods and only the patterns P are changed in these two methods.

The simulation results of the present methods will be considered in the following section and compared with the LFSR algorithm.

iii) Simulation Results

The separate tile-based attention method has been developed with the aim of reaching the lowest possible connection in the first junction of MLPs. In order to simulate the method, an MLP network [784, 49, 49, 10] is implemented. The 49 neurons are selected because MNIST images can be divided into 49 separate patches containing 4×4 pixels. The first junction of the network is sparsely connected; all other junctions are fully connected. The total number of trainable parameters is 41307 for the FC network. However, the method only contains 3675 trainable parameters.

A Rectified Linear Units (ReLu) activation function is located at the output of each neuron except the output neurons placing Softmax functions. Simulation results of sparsely-connected (SC) networks show a slight drop in performance compared to the fully-connected (FC) network. The fully-connected (FC) network with 49 neurons for the first and second hidden layers can reach high accuracy for MNIST datasets. However, one cannot expect to reach high accuracy for the sparsely-connected (SC) network for KMNIST, as the fully-connected (FC) network needs to perform satisfactorily when the KMNIST dataset is applied.

Table II below shows simulation results for sparsely-connected (SC) networks that occurred in the first junction, and separate tile-based attention is also exploited.

TABLE II
PYTHON SIMULATION RESULTS FOR SEPARATE TILE-BASED
ATTENTION (MINIMAL POSSIBLE CONNECTIONS)

| | Fully Connected | Separate Tile | |
|---|---|---|---|
| | Network | Attention | 2% Sparse¹ |
| NN [784, 49, 49, 10] | Accuracy | | |
| MNIST | 96.5% | 94.5% | 93% |
| KMNIST | 80% | 76% | 75% |
| Trainable Parameters | 41307 | 3675 | 3695 |

¹Ardakani et al., “Sparsely-connected neural networks: towards efficient VLSI implementation of deep neural networks,” in arXiv, 2016.

The second approach was introduced to reach a higher connection and more neurons in the first hidden layer. This approach was implemented by a neural network [784,121,60,10]. Both fully-connected and sparsely-connected models were simulated to examine the benefits of the method. A fully connected network includes 102700 trainable parameters, while a sparsely connected network needs 15604 trainable ones. Moreover, 121 neurons are required for the first hidden layer because a window of 8×8 pixels and stride 2 is exploited for overlapped tile-based attention.

Table III below indicates inference prediction and the number of trainable parameters in each design, if MNIST and KMNIST were input, respectively.

TABLE III
PYTHON SIMULATION RESULTS FOR OVERLAPPED
TILE-BASED ATTENTION ALGORITHM

| | |
|---|---|
| Fully Connected | Overlapped Tile |
| Network | Attention |

| | |
|---|---|
| NN [784, 121, 60, 10] | Accuracy |

| | | |
|---|---|---|
| MNIST | 97.35% | 96.1% |
| KMNIST | 86.7% | 84.86% |
| Trainable Parameters | 102724 | 15604 |

Matrix multiplication is the central core of neural networks. Matrix multiplication can be implemented by parallel processing using graphics processing units (GPUs). However, wiring congestion and parallel access to memory are the main problems resulting in high power consumption and large silicon area. These problems prevent from using GPUs as the best options for implementation. Very Large Scale Integration (VLSI) implementation provides a significantly higher speed, but it is not cost-effective; while Field Programmable Gate Arrays (FPGAs) are cost-effective and prototypes can be implemented rapidly. The present methodology is very effective in both VLSI and FPGA implementation, but the applicant has concentrated on FPGA implementation.

One important contribution of the invention relates to predicting speedup improvements. While zero values do not need to store, only non-zero weights according to the pattern will emerge in the calculation. Consequently, each method's number of trainable parameters is expected to represent the network's latency, specifically for FPGA implementation. Equation (5) below serves as a prediction of the latency improvement compared to the fully connected network.

$$Ω = \frac{Total number of FC trainable parameters}{Trainable parameters of proposed method} \qquad ( 5 )$$

As long as Ω is higher, the applicant expects to reach a lower value for latency and a higher value for speed. Table IV (below) considers values for different methods. It is important to note that value cannot be used for other literature because they use randomized and irregular pattern of removal. Separate tile-based attention has the highest value for speedup prediction value (Q) and holds the minimum possible parameters for W₁. This capability inspired the applicant to implement the separate tile-based attention using XC7S100 (Spartan-7).

Table IV indicates that the separate-tile based attention only contains 3675 trainable parameters, while a fully connected network needs 41307 trainable parameters. Although the accuracy experienced a degradation in both Ardakani et al., “Sparsely-connected neural networks: towards efficient VLSI implementation of deep neural networks” in arXiv, 2016 (hereinafter, Ardakani et al.) and the present algorithm, reducing the number of trainable parameters in Ardakani et al. allows then to reduce memory usage. The separate tile-based attention reduces memory usage and improves latency simultaneously. The latency can be improved more than 11 times compared with Ardakani et al. and a fully connected network.

TABLE IV
SPEED IMPROVEMENT PREDICTION FOR SEPARATE
AND OVERLAPPED TILE BASED ATTENTIONS

| Network | [784, 49, 49, 10] | [748, 121, 60, 10] |
|---|---|---|
| FC Trainable Parameters | 41307 | 102724 |
| SC Trainable Parameters | 3675 | 15604 |
| Speed Improvement Factor | 11.24x | 6.58x |

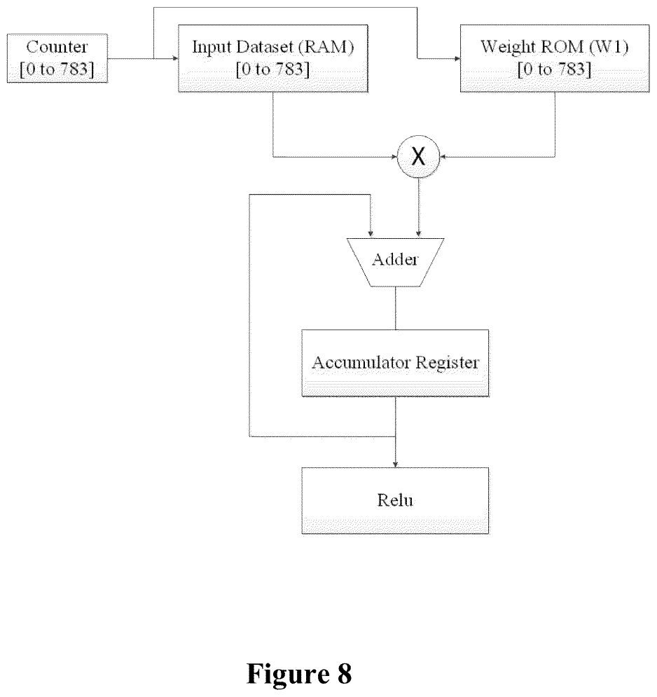

For FPGA implementation, multiply-and-accumulate (MAC) units for the first-junction calculation shown in FIG. 8 are used. The total number of inputs represents the total multiplication and latency. In other words, a fully connected network with 784 inputs and 49 neurons for the first hidden layer requires 38416 multiplication steps which contain more than 90% of total calculations. Reducing those numbers in a regular manner allows one to reach a higher speed than the fully connected network. Likewise, in randomized or pruned algorithms, several inputs have zero values. Zero multiplication and summation can be ignored simply with an enable signal introduced in Ardakani et al. However, the enabling signal could not reduce the latency, and the role of enabling signal is only to reduce memory usage.

Despite pruned and randomized algorithms, the present method does not require to store all values for weights and inputs, especially for the first junction. Only 784 inputs and 784 weights are required. The value of the first-hidden-layer neuron is the summation of 16 consecutive multiplications or the windows to which the neuron is connected. As a consequence, only 784 multiplication and summation for the first hidden layer calculation is needed. The applicant uses serial computation rather than parallel processing. The present method was based on serial calculation. The input and weight are fed serially into the MAC block, and each layer only exploits one MAC unit.

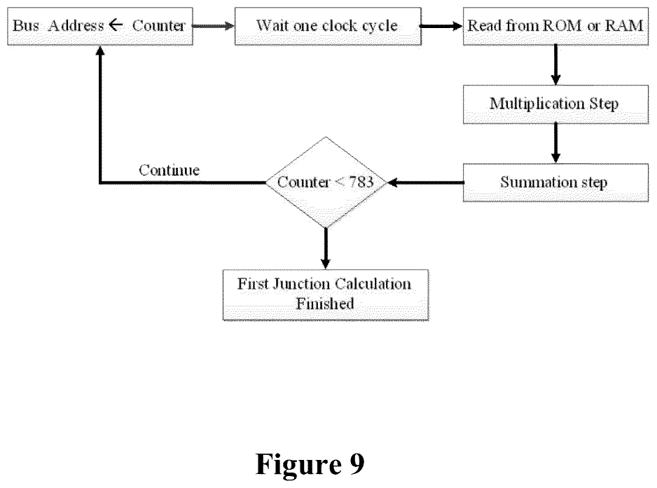

As long as a serial computation is utilized, the different state of calculation needs to be considered. FIG. 9 depicts different steps for each calculation. As it is shown, five clock cycles for each multiplication are required. In other words, for a fully connected network, a 206535 clock cycle is needed for the output to be validated. Nevertheless, the method only requires an 18375 clock cycle for output validation. In other words, the method will reduce the latency more than 11 times rather than the fully connected network with the similar dimension.

While not essential, in order to implement the present method, Vivado™ for hardware implementation and Modelism for simulation are preferably used.

An exemplary design was implemented on a Xilinx™ XC7Z100 and XC7S100 FPGA. Table V (below) shows the resource utilization for Zynq™ and Spartan™ FPGA, respectively. The implementation includes two parts: store the MNIST dataset into a RAM in a 24-bit signed fixed-point format. The sign fixed format includes one bit for a sign, 7 bits for a digit and 16 bits for the fraction. The second part includes feed forward calculation. For each layer, only one MAC block was used, but due to the large length, two multiplication blocks (DSP48s) were exploited in each layer.

TABLE V
RESOURCE UTILIZATION OF FPGA FOR SEPARATE
TILE BASED ATTENTION NETWORK

| | |
|---|---|
| XC7Z100 | XC7S100 |

| Resources | Utilization | Available | Utilization | Available |
|---|---|---|---|---|
| LUT | 3141 | 277400 | 3174 | 64000 |
| FF | 5308 | 554800 | 5308 | 176000 |
| BRAM | 3 | 755 | 3 | 120 |
| DSP | 6 | 2020 | 6 | 160 |

Table VII (below) compares the performance of separate tile-based attention with previous state-of-the-art accelerators implemented on FPGAs, namely: Li et al., “A fast and energy-efficient SNN processor with adaptive clock event-driven computation scheme and online learning,” in IEEE Trans. Circuits Syst. I, Reg. Papers, vol. 68, no. 4, pp. 1543-1552, April 2021 [17]; Fang et al., “Encoding, model, and architecture: Systematic optimization for spiking neural network in FPGAs,” in Proceedings of the 39th International Conference on Computer-Aided Design. November 2020, pp. 1-9 [18]; Zhang et al., “An Asynchronous reconfigurable SNN accelerator with event-driven time step update,” in 2019 IEEE Asian Solid-State Circuits Conference (A-SSCC), Macau, Macao, 2019, pp. 213-216.D [19]; Ma et al., “Darwin: A neuromorphic hardware co-processor based on spiking neural networks,” in Journal of systems architecture, vol. 77, pp. 43-51, 2017 [20]; Chen et al., “Cerebron: A Reconfigurable Architecture for Spatiotemporal Sparse Spiking Neural Networks,” in IEEE Transactions on Very Large Scale Integration (VLSI) Systems, vol. 30, no. 10, pp. 1425-1437, October 2022 [21]; and Zhang et al., “Caffeine: Toward Unformed Representation and Acceleration for Deep Convolutional Neural Networks” in IEEE Transactions on Computer-Aided Design of Integrated Circuits and Systems, vol. 38, no. 11, pp. 2072-2085, November 2019 [22], the entirety of all of the aforementioned publications which are hereby incorporated herein by reference.

Comparing the present method with previous state-of-the-art accelerators shows an improvement in latency, except [21], which has a better performance in latency and accuracy. But due to an exceptional use of Look-Up Tables (LUTs), the present method is much more effective. Considering the area consumption of different topologies and the amount of each topology consumed for every unit accuracy improvement can help researchers determine which topology is best suited for their particular application and optimize energy consumption.

Table VI (below) represents and compares the present method with the above-listed literatures in terms of resource utilization.

TABLE VI
COMPARES THE RESOURCE UTILIZATION
REGARDING AREA

| Metric | [20] | [21] | [22] | Present Method |
|---|---|---|---|---|
| FPGA Platform | Spartan-6 | XC7Z100 | KU060 | XC7Z100 |
| LUT | 11489 | 85926 | 140,000 | 3141 |
| FF | 4705 | 70544 | 200,000 | 5308 |
| BRAM | 110 | 283 | 784 | 3 |
| DSP48s | 36 | 0 | 116 | 6 |

TABLE VII
COMPARISON WITH PREVIOUS STATE-OF-THE-ART ACCELERATORS

| | | | | | | | Present |
|---|---|---|---|---|---|---|---|
| Metrics | [17] | [18] | [19] | [20] | [21] | [22] | Method |
| FPGA platform | VC707 | XCZU9EG | XC7VX690T | Spartan-6 | XC7Z100 | KU060 | XC7Z100 |
| Dataset/Input Size | MNIST/784 | | | | | | |
| Model | MLP | MLP | MLP | MLP | ConvNet | CNN | MLP |
| Accuracy | 92.93% | 98.96% | 98% | 93.8% | 99.4% | — | 93.77% |
| Clock Frequency (MHz) | 100 | 125 | — | 25 | 200 | 200 | 271 |
| On-chip Power (W) | 1.6 | 4.5 | 0.7 | — | 1.4 | 25 | — |
| Latency (ms)/Image | 3.15 | 0.52 | 1.09 | 160 | 0.026 | 25.3 | 0.068 |

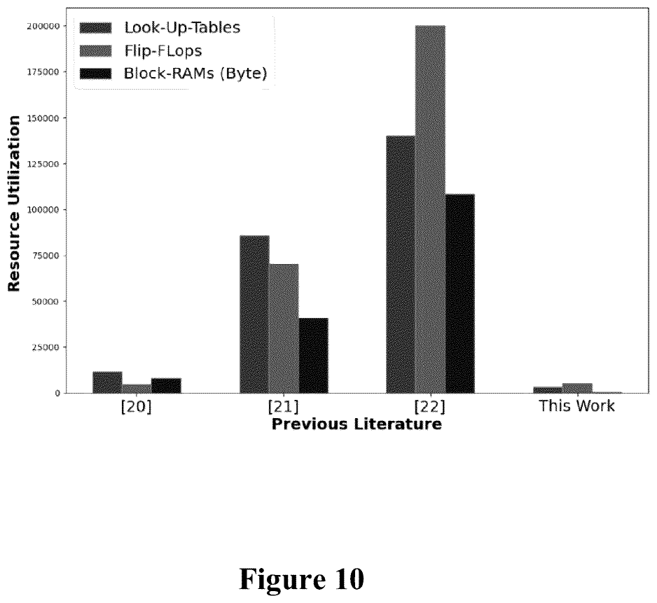

FIG. 10 represents the resource utilizations associated with the area. This graph shows an exceptional improvement in resource utilization in comparison with state-of-the-art literatures. Meaning that this method requires a small number of resources for implementation. The inference; however, needs 0.068 ms for every image to be evaluated.

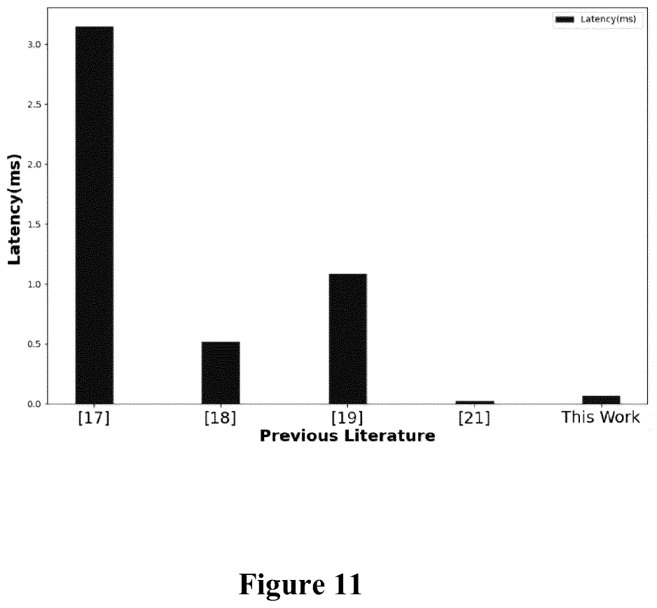

FIG. 11 shows the comparison between the present method and state-of-the-art literature in terms of speed and latency. Because the latency of [20] and [22] is high above the others, they have been omitted as a part of the comparison.

The present methodology achieved better performance in both area consumption and latency compared to previous literature, except for the findings presented in [21], which used a higher number of resources. High resource utilization for [21] does not allow the designer to implement it on Spartan™-7 or any FPGAs with lower resources.

### iv) Comparison to Convolutional Neural Networks

Convolutional Neural Networks (CNNs) leverage kernels and strides in their convolutional layers to update weights and conduct feature extraction. The total number of multiplications in a CNN is contingent upon several factors, encompassing network architecture, input data size, filter dimensions (kernels), and the quantity of filters in each layer. On the flip side, if one presumes the same window and stride dimensions for both the present method and CNN, the resulting multiplication counts remain comparable. A key distinction lies in the absence of a sweeping kernel in the applicant's approach. The sweeping approach contributes to feature extraction. While in the present method, each neuron is intricately connected to distinct input windows, holding unique weights, leading to classification.

In contrast, CNNs employ a uniform kernel that progressively extracts features across the entire image. The present method focuses on local scrutiny of the image, introducing sparsity through window and stride attention. It's crucial to highlight that this localized approach doesn't compromise accuracy when compared to fully connected networks.

An additional distinction from CNNs lies in their utilization of max or average pooling, along with flatten layers, often followed by one or more fully connected networks. In contrast, the applicant's approach achieves classification using a subsequent compact dense layer alone. This streamlined architecture highlights an efficiency in classification without the need for extensive pooling and multiple fully connected layers, contributing to a more concise and potentially computationally efficient model.

### v) Applications of Tile-Based Attention

In one possible non-limiting application, the real-time object detection by autonomous vehicles may be one model that can be used to detect different road signs and lanes for autonomous vehicles. Its response time is much faster than the state-of-the-art model. Sensors used to collect real-time data from the physical world, such as image, temperature, pressure, or motion. An MLP may be used to process sensor data signals to perform various tasks, such as classification, regression, or anomaly detection. This model can respond faster and be more compact than current models in the marketplace.

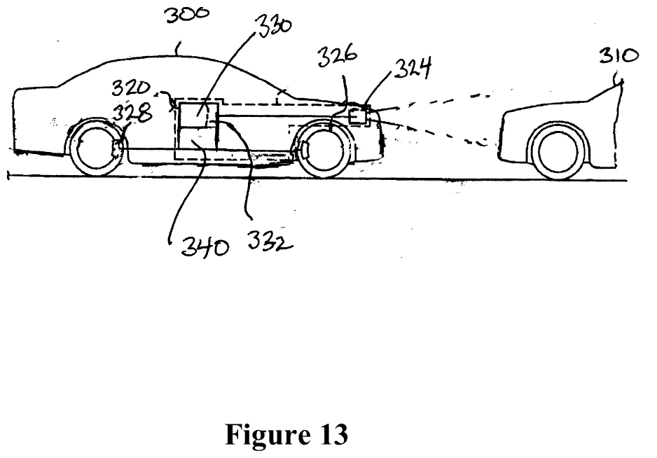

The present invention can potentially be used for embedded devices, sensor-less drivers, as well as with sensors and preferably sensors which in themselves possess low or limited processing power, such as image sensors, distance sensors and optical sensors used with autonomous and/or vehicles. In one preferred embodiment, the present invention may be used in conjunction with ICE and EV vehicle sensor systems and which incorporate LIDAR and/other optical sensors used for the detection of electromagnetic radiation as part of vehicle control systems for antifatigue detection, lane guidance, cruise control and/or crash avoidance. Reference may be had to FIG. 13 which illustrates schematically an EV vehicle 300 which incorporates a collision avoidance system 320 operable to prevent or reduce potential collisions with a next vehicle 310.

The system 320 includes a series of sensors including a vehicle optical sensor array 324 which is comprised of a number of image sensors adapted to receive electromagnetic radiation in the visible light and infrared wavelength range, as well as vehicle speed and braking sensors 326, 328 which electronically communicate with a vehicle processor/controller 330.

The sensor array 324 is operable to provide electronic signals representative of sensed pixels to the vehicle system processor 330, and which in turn is adapted to output control signals to an autonomous emergency braking (AEB) system 346 which is configured to effect autonomously, vehicle braking on the occurrence of an identified collision threat.

The vehicle processor 330 includes an internal memory 332 which stores programme instructions for the analysis of data signals received from the sensor array 324 and/or sensors 326, 328 and the output control signals to the AEB system 340 based thereon.

More preferably, the memory 332 stores processing instructions for the analysis of input data signals by way of a sparsified MLP network which has been predetermined. Most preferably the stored processing instructions have previously been statistically validated as part of an earlier training process, and in which pruning has been previously optimized to a preselected degree of accuracy.

In a preferred operational mode, photosensitive pixels of the image sensors in the optical sensor array 324 are used to convert detected optical image features to electronic signals which are communicated to the processor 330 as an array or a data packet.

The processor software stored in memory 332 allocates the input signals which are received into groupings of the number of pixels which are to be connected to each neuron in the stored MLP in a first hidden layer, according to the previously determined optimized programme.

Processing of the electronic signals is effected with each neuron in the first hidden layer being sparsely connected to those in the next hidden layer in accordance with the preselected sparsity, only.

The applicant has appreciated that as a result, the system processor 330 may operate with the preselected constant number of junctions between neurons which have been preselected to remove unnecessary connections. This in turn minimizes processor decision making and processing requirements of the system processor 330, reducing power load requirements associated therewith.

Using on the sparse MLP processing an attributed value is generated based on the detected optical image features, and which is used to generate and output a control signal for the AEB system 340. As a result, the AEB system 340 and EV vehicle 300 may operate in response to the control signal with lessened processing requirements, and increased power efficiency.

While FIG. 13 describes the operation of the processor 330 as used with an EV vehicle 300 and with an optical sensor array 324 and/or vehicle speed and braking sensor 326, 328, the invention is not so limited. Potential other applications therefore may be to implement neural networks on embedded devices having limited resources/processing/digital inputs. These applications may for example include sensor-less motors, iot devices, wearable tech, and other smart sensors. Sparse training can significantly reduce the number of parameters in a neural network, making the model both compact and faster.

The applicant has appreciated that embodiments of the MLPs of the present invention may, for example, be used in one or more sensor system applications incorporating various types of sensors, including but not limited to one or more of the following: cameras including high-resolution cameras, optical sensors, object detection sensors, driver-less sensors, autonomous vehicle sensors, thermal cameras, lidar sensors, thermocouples, thermistors, humidity sensors, flow sensors, padwheel sensors, ultrasonic sensors, microphones, acoustic sensors, pressure sensors, level sensors, various industrial sensors, gas sensors, light sensors, accelerometers, gyroscopes, inertial measurement units (IMUs), optical heart rate sensors, position and/or displacement sensors, pressure sensors, resistive sensors integratable into wearable or medical devices, piezoelectric sensors, force sensors, mmWave sensors, spirometers, accelorometers, cuff-based oscillometric sensors, electrochemical sensors, chromogenic sensors, magnetic sensors, interferometers, polarimeters, reflectometers, hall effect sensors, coils, magnetometers and electromagnetic field (EMF) meters. And that said above-noted sensors may be used, by way of non-limiting example, to capture and/or measure various physical phenomena, including for example one or more of: visual information, temperature, pressure, pressure fluctuations, light levels, air quality, sound, humidity, material flow, state of machinery, rainfall, water levels, heart rate, respiration, blood pressure, sweat, tears, body position, body movement, mechanical movement, vibrations, acceleration, other physiological signals, plasma position, and electromagnetic fields.

In such sensor system applications, the applicant has appreciated that a sensor interface may for example be used in converting measurements taken by one of more sensors into a format that is acceptable for input to the MLP, and that the transformed sensor data may then be fed to the MLP for processing and analysis, including classification and regression inference, and for outputting of various control signals based on the analysis results.

The applicant has appreciated that the above-noted model may, for example, be of particular value in wearable technology, wherein biophysical measurements may be taken, transmitted and thereafter digested by the MLP in order to detect medical and/or physiological conditions and cause such further actions through issuing of control signals to produce alerts or alarms. The present technology can be implemented on various platforms with advances in compactness and higher speed. It is evident that in FPGA and ASIC, the technology will enhance system speed by reducing the number of parameters and multiplications. On the GPU, it can potentially reduce energy consumption due to the smaller number of parameters.

The applicant has appreciated that sparsification of MLPs according to embodiments of the present invention may advantageously result in application of such artificial neural networks in devices having limited power and processing capabilities. By way of non-limiting example, the applicant has contemplated that separate and overlapped tile-based MLPs according to the present invention may be implemented through the cost-effective mass manufacture of dedicated integrated circuits (ICs) or more preferably through the provision of configuration data (by way of bitstream), which may be used to directly program/transform (i.e. physically rewire and configure/reconfigure) field-programmable gate arrays (FPGAs).

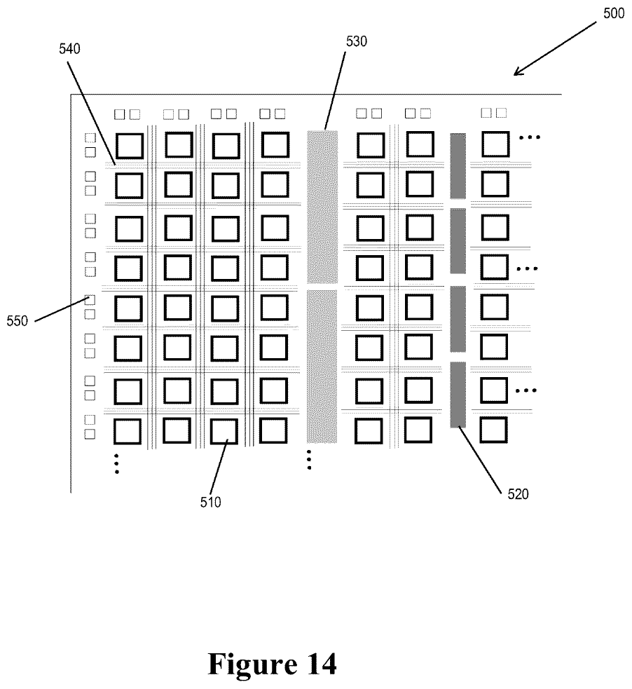

FIG. 14 provides a partial diagram of one possible example of an FPGA chip 500, which includes the following components: a plurality of configurable logic blocks (CLBs) 510, which may for example include look-up tables (LUTs) and Flip-Flops (FFs); a plurality of digital signal processing (DSP) slices 520, which may for example include multiply and accumulate (MAC) units; one or more Block RAM (BRAM) 530; a plurality of programmable interconnects 540; and a plurality of input/output (I/O) blocks 550. In order to program/transform the FPGA 500 into a custom hardware accelerator for implementing the MLP, the bitstream including the relevant configuration data must be loaded into the BRAM 530 of the FPGA 500. Preferably, the bitstream is stored on an external non-volatile memory device such as, for example, a serial peripheral interface (SPI) flash memory chip. During a configuration phase, the memory device is connected to the FPGA 500 by means of the I/O blocks 550 and/or by means of an external memory interface, which allows for the transfer of the bitstream from the memory device to the BRAM 530. Thereafter, each of the various components of the FPGA 500 (i.e. the CLBs 510, DSP slices 520, programmable interconnects 540, BRAM 530 and I/O blocks 550) are configured in accordance with the configuration data of the bitstream in order to transform/reconfigure the FPGA to function as the MLP.

ICs or FPGAs which are manufactured and/or configured to function as sparsely connected (SC) multi-layer perceptrons (MLPs) according to preferred embodiments of the invention are particularly suited to regression and classification tasks, and thus may be especially advantageous when used for processing data and/or in incorporating artificial intelligence (AI) in wearable sensor-based systems and embedded devices.

We claim:

1. An external non-volatile memory device, preferably an SPI flash memory chip, storing thereon a bitstream comprising configuration data for programming a Field-Programmable Gate Array (FPGA), said configuration data comprising instructions executable by a computer processor or one or more components of the FPGA, and which when executed by the computer processor or the one or more components of the FPGA effectuate physical rewiring and reconfiguration/transformation of the FPGA into a custom hardware accelerator for a sparsely-connected (SC) artificial neural network, namely a Multi-Layer Perceptron (MLP), said SC MLP comprising an interconnected layers architecture, and in particular comprising:
an input layer (0) comprising N₀ neurons;
one or more hidden layers comprising N₍ᵢ₋₁₎ and Nᵢ neurons, respectively, in earlier and later layers of said one or more hidden layers;
an output layer (L) comprising N_{L} neurons;
a first junction between said input layer (0) and a first hidden layer (1) of said one or more hidden layers, said first junction having a weight matrix W₁;
one or more junctions between successive layers of said one or more hidden layers, said one or more junctions each having a weight matrix Wᵢ; and
a final junction between a last hidden layer (L−1) of said one or more hidden layers and said output layer (L), said final junction having a weight matrix W_{L};
wherein predictive forward computations of said SC neural network are calculated as follows:
$${Y}_{i} = Act ( {\sum }_{i} {W}_{s} {X}_{i - 1} )$$
wherein X and Y are inputs and outputs, respectively, at successive layers of the MLP;
wherein Act defines an activation function of the MLP;
wherein Wₛ is calculated using a regular, predefined pattern or mask P as follows:
$${W}_{s} = {W}_{1} P$$
wherein the pattern P is operable to assemble a sparse pattern in the neural network, particularly in the first junction;
wherein the pattern P is also applied in backpropagation paths for training and learning; and
wherein fan-in for the first hidden layer (1) is kept fixed using the pattern P.

2. The external non-volatile memory device of claim 1,
wherein the pattern P comprises a cascading matrix pattern of 0s and 1s, wherein the matrix is primarily filled by 0s with a plurality of substantially parallel, staggered and downward slanting lines of 1s descending from a substantially upper left corner of the matrix across to a substantially lower right corner of the matrix in a substantially step-wise, diagonal pattern; and
wherein the pattern P is preferably produced by way of Algorithm 1 as follows:
```
  1: Input: N, K
  2:  ${N}_{1} ← {( \frac{N}{K} )}^{2}$
  3: M₀ ← Zeros N₁, N, N]
  4: Z ← 0
  5: Y ← 0
  6: while Y + K ≤ N do
  7: X ← 0
  8: while X + K ≤ N do
  9: M₀[Z, Y : Y + K, X : X +K ] ← 1
10: Z ← Z + 1
11:  X ← X + K
12: end while
13: Y ← Y + K
14: end while
15: M₀ ← M₀.Reshape[N₁, N²]
16: Output: M₀
```
N representing a total number of input units (neurons) in the first hidden layer, K representing a number of tile connections, and the pattern P being matrix M₀ that is first generated in three dimensions (3D) having X, Y and Z axes and then converted by way of the Algorithm 1 into two dimensions (2D) with X and Y axes representing the number of inputs and the number of neurons at the first hidden layer, respectively.

3. The external non-volatile memory device of claim 1,
wherein the pattern P comprises a cascading matrix pattern of 0s and 1s, wherein the matrix is primarily filled by 0s with a plurality of substantially parallel, staggered and downward slanting lines of 1s descending from an upper left portion of the matrix across to a lower right portion of the matrix, and forming a relatively thicker grouping of substantially parallel lines in a substantially diagonal pattern;
and wherein the pattern P is preferably produced by way of Algorithm 2 as follows:
```
  1: Input: N, K, S
  2: ${N}_{1} ← {( \frac{N - K}{S} + 1 )}^{2}$
  3: M₀ ← Zeros N₁, N, N]
  4: Z ← 0
  5: Y ← 0
  6: while Y + K ≤ N do
  7: X ← 0
  8: while X + K ≤ N do
  9: M₀[Z, Y : Y + K, X : X +K ] ← 1
10: Z ← Z + 1
11: X ← X + S
12: end while
13: Y ← Y + S
14: end while
15: M₀ ← M₀.Reshape[N₁, N²]
16: Output: M₀
```
N representing a total number of input units (neurons) in the first hidden layer, K representing a number of tile connections, S representing a sliding of a tile for connection of the first hidden layer to the input layer, and the pattern P being matrix M₀ that is first generated in three dimensions (3D) having X, Y and Z axes and then converted by way of the Algorithm 2 into two dimensions (2D) with X and Y axes representing the number of inputs and the number of neurons at the first hidden layer, respectively.

4. The external non-volatile memory device of claim 2,
wherein the input layer (0) comprises a collection of tiles, preferably 49 tiled windows each comprising 4×4 pixels;
wherein the first hidden layer (1) preferably comprises 49 neurons; and
wherein each said neuron of the first hidden layer (1) is symmetrically connected to a single said window and ignores all other said windows.

5. The external non-volatile memory device of claim 3,
wherein the input layer (0) comprises a collection of tiled windows which are successively read and fed to the MLP from an input measuring A×A pixels, using a stride measurement selected from 1 to A and a Window Size of B×B pixels, wherein B is smaller than A;
wherein a number of neurons N₁ in the first hidden layer (1) is calculated as follows:
$${N}_{1} = {( \frac{Input Size - Window Size}{Stride} + 1 )}^{2}$$
wherein Input Size is A, Window Size is B and Stride is the stride measurement selected from 1 to A.

6. The external non-volatile memory device of claim 1, wherein the MLP is used to perform regression and/or classification tasks.

7. An FPGA programmed using the external non-volatile memory device of claim 1, the FPGA comprising:
a plurality of configurable logic blocks (CLBs) comprising look-up tables (LUTs) and Flip-Flops (FFs);
a plurality of digital signal processing (DSP) slices comprising multiply and accumulate (MAC) units;
a Block RAM (BRAM) connected to an external memory interface;
a plurality of programmable interconnects; and
a plurality of input/output (I/O) blocks;
wherein the bitstream is loaded into the BRAM from the external non-volatile memory device via the external memory interface and/or I/O blocks during a configuration phase;
wherein each of the plurality of CLBs, DSP Slices and programmable interconnects, the BRAM and the I/O blocks are configured in accordance with the configuration data of the bitstream to reconfigure/transform the FPGA to function as the SC MLP; and
wherein at least one said MAC units are operable to perform computations and/or calculations for implementing at least one of said first junction, one or more junctions and final junction of the MLP.

8. A custom integrated circuit (IC) or Application-Specific Integrated Circuit (ASIC) designed and hard-wired to perform operations and calculations of, and to function as, a sparsely-connected (SC) artificial neural network, namely a Multi-Layer Perceptron (MLP), said SC MLP comprising an interconnected layers architecture, and in particular comprising:
an input layer (0) comprising N₀ neurons;
one or more hidden layers comprising N₍ᵢ₋₁₎ and Nᵢ neurons, respectively, in earlier and later layers of said one or more hidden layers;
an output layer (L) comprising N_{L} neurons;
a first junction between said input layer (0) and a first hidden layer (1) of said one or more hidden layers, said first junction having a weight matrix W₁;
one or more junctions between successive layers of said one or more hidden layers, said one or more junctions each having a weight matrix Wᵢ; and
a final junction between a last hidden layer (L−1) of said one or more hidden layers and said output layer (L), said final junction having a weight matrix W_{L};
wherein forward computations of said SC neural network are calculated as follows:
$${Y}_{i} = Act ( {\sum }_{i} {W}_{s} {X}_{i - 1} )$$
wherein X and Y are inputs and outputs, respectively, at successive layers of the MLP;
wherein Act defines an activation function of the MLP;
wherein Wₛ is calculated using a regular, predefined pattern P as follows:
$${W}_{s} = {W}_{1} P$$
wherein the pattern P is operable to assemble a sparse pattern in the neural network, particularly in the first junction;
wherein the pattern P is also applied in backpropagation paths for training and learning; and
and wherein the pattern P is produced by way of Algorithm 2 as follows:
```
  1: Input: N, K, S
  2:  ${N}_{1} ← {( \frac{N - K}{S} + 1 )}^{2}$
  3: M₀ ← Zeros N₁, N, N]
  4: Z ← 0
  5: Y ← 0
  6: while Y + K ≤ N do
  7: X ← 0
  8: while X + K ≤ N do
  9: M₀[Z, Y : Y + K, X : X +K ] ← 1
10: Z ← Z + 1
11: X ← X + S
12: end while
13: Y ← Y + S
14: end while
15: M₀ ← M₀.Reshape[N₁, N²]
16: Output: M₀
```
N representing a total number of input units (neurons) in the first hidden layer, K representing a number of tile connections, S representing a sliding of a tile for connection of the first hidden layer to the input layer, and the pattern P being matrix M₀ that is first generated in three dimensions (3D) having X, Y and Z axes and then converted by way of the Algorithm 2 into two dimensions (2D) with X and Y axes representing the number of inputs and the number of neurons at the first hidden layer, respectively.

9. The IC or ASIC of claim 8, wherein the S and K in Algorithm 2 are the same, which results in the pattern P suitable for implementing separate tile-based attention.

10. The IC or ASIC of claim 8, wherein the S is smaller than the K in Algorithm 2, which results in the pattern P suitable for implementing overlapped tile-based attention.

11. An Internet of Things (IoT) device comprising the IC or ASIC of claim 8.

12. A smart sensor device comprising the IC or ASIC of claim 8.

13. An embedded device comprising the FPGA of claim 7.

14. A smart sensor device comprising the FPGA of claim 7.

15. A sensor system comprising the FPGA of claim 7, the sensor system characterized by reduced processing and power requirements, and further comprising:
at least one sensor; and
a sensor interface connecting the at least one sensor to the IC/ASIC or the FPGA;
wherein said at least one sensor is operable to measure a physical phenomenon and transmit said measurements in the form of data signals to the sensor interface;
wherein the sensor interface is operable to receive said data signals, to convert said data signals into digital data interpretable by the IC/ASIC or the FPGA, and to transmit said digital data to the IC/ASIC or the FPGA;
wherein the IC/ASIC or the FPGA is operable to receive said digital data, to analyze and interpret said data by means of forward propagation through said interconnected layers architecture in order to identify data patterns indicative of the physical phenomenon, and to output control signals in response to said data patterns.

16. The sensor system of claim 15,
wherein the digital data interpretable by the IC/ASIC or the FPGA comprises a plurality of two-dimensional images, each of said images preferably measuring 28×28 pixels divisible into 49 tiled windows each with 4×4 inputs; and
wherein the IC/ASIC or the FPGA is further operable to assign and/or to compile said images to/into the input layer (0) of the MLP.

17. The sensor system of claim 15,
wherein the interconnected layers architecture of the MLP is designed to contain a preselected minimum or maximum number of total neural connections between neurons of each of the input layer (0), the one or more hidden layers, and the output layer (L); and
wherein said preselected minimum or maximum number of total neural connections is designed for achieving a target degree of system accuracy while also minimizing processing and power requirements of the MLP.

18. A wearable device comprising the sensor system of claim 15,
wherein the physical phenomenon comprises at least one of: temperature, heart rate, respiration, blood pressure, blood oxygen, sweat, tears, body position, body movement, mechanical movement, or other physiological signals; and
wherein the at least one sensor is selected from the group consisting of: temperature sensors, accelerometers, gyroscopes, optical heart rate sensors, position and/or displacement sensors, pressure sensors, resistive sensors and other physiological sensors including electrocardiogram (ECG), photoplethysmography (PPG), electromyography (EMG), blood oxygen sensors and galvanic skin response (GSR) sensors; and
wherein the control signal is operable to control an alarm or alert for alerting a user of the wearable device to a predefined medical or physiological state.

19. A collision avoidance system, preferably for an autonomous or EV vehicle, comprising the sensor system of claim 15,
wherein the physical phenomenon comprises at least one of: electromagnetic radiation in the visible light and infrared wavelength range, vehicle speed and acceleration; and
wherein the at least one sensor is selected from the group consisting of: image sensors, distance sensors, object detection sensors, lidar sensors, optical sensors, vehicle speed and braking sensors; and
wherein the control signal is operable to control vehicle braking on occurrence of an identified collision threat.

20. A method of operating a sensor system comprising the IC or ASIC of claim 8, the system characterized by reduced processing and power requirements, the method comprising:
by way of at least one sensor, measuring a physical phenomenon and transmitting said measurements in the form of data signals to a sensor interface, said sensor interface connecting the at least one sensor to the IC/ASIC or the FPGA;
receiving from said at least one sensor to the sensor interface, the data signals;
by way of said sensor interface, converting said data signals into digital data interpretable by the IC/ASIC or the FPGA;
by way of said sensor interface, transmitting said digital data to the IC/ASIC or the FPGA;
receiving to the IC/ASIC or the FPGA said digital data;
by way of said the IC/ASIC or the FPGA, analyzing and interpreting said data by means of forward propagation through said interconnected layers architecture in order to identify data patterns indicative of the physical phenomenon; and
outputting control signals in response to said data patterns.
